(19) United States
(12) Patent Application Publication
(10) Pub. No.: US 2012/0252426 A1
(43) Pub. Date: Oct. 4, 2012

(54) ELECTRONIC DEVICE AND SCHEDULING CONTROL COMPUTER PROGRAM

(75) Inventors: Kazuma NAGAOKA, Kawasaki (JP); Hayato SASAKI, Kawasaki (JP); Katsuhiko TAKAHASHI, Kawasaki (JP); Takamichi ABE, Kawasaki (JP)

(73) Assignee: FUJITSU LIMITED, Kawasaki-shi (JP)

(21) Appl. No.: 13/355,682

(22) Filed: Jan. 23, 2012

(30) Foreign Application Priority Data
Mar. 28, 2011 (JP) 2011-071159

(51) Int. Cl. H04W 88/02

(52) U.S. Cl. 455/418

(57) ABSTRACT

A mobile phone includes a condition storage unit storing therein a condition related to periodically-scheduled events that involve ringing of a device. In addition, the mobile phone includes a judging unit that judges whether an input operation input via an input unit of the device matches the condition stored in the condition storage unit. The mobile phone also includes a skip processing unit that, when the judging unit determines that the input operation matches the condition, inhibits the ringing scheduled at a nearest ringing time from being performed, calculates a ringing time that arrives following the nearest ringing time according to a periodical schedule, and configures a setting so as to enable the ringing scheduled at the calculated ringing time.

### CROSS-REFERENCE TO RELATED APPLICATION

This application is based upon and claims the benefit of priority of the prior Japanese Patent Application No. 2011-071159, filed on Mar. 28, 2011, the entire contents of which are incorporated herein by reference.

### FIELD

The embodiment discussed herein is directed to an electronic device and a scheduling control computer program.

### BACKGROUND

Electronic devices such as mobile phones that have a so-called repeatedly-scheduling-event function are conventionally known, which is to perform a process set in advance (e.g., to ring an alarm) at a date/day-of-the-week/time that is set in advance.

To specify a repetition date/time for the repeatedly-scheduling-event function of such electronic devices, a date, a specific date every year, a specific date every month, everyday, a specific day of the week, or the like may be specified. For example, if “everyday” is selected, the scheduled process is repeatedly performed everyday. If a specific day of the week is specified, the scheduled process is repeatedly performed on the specific day of the week every week.

When the repeatedly-scheduling-event function is used, once the setting is configured, the electronic device is caused to repeatedly perform the scheduled process as many times as specified. However, according to the conventional repeatedly-scheduling-event function, even if the user wishes to cancel, only on a certain day, the arrangement to have the scheduled process performed (hereinafter, “scheduled event”), from among the arrangements to have the scheduled process performed repeatedly (hereinafter, “repeatedly-scheduled events”), the user has no choice but to cancel the entire repeatedly-scheduled events. Thus, the operability is not at a satisfactory level.

To improve the operability, Japanese Laid-open Patent Publication No. 2008-128765 discloses a technique for cancelling the scheduled event only for a specific day or a specific time period from among the repeatedly-scheduled events.

According to the method for cancelling the scheduled event described in the document listed above, however, the user needs to perform a complicated operation even if he/she wishes to cancel only the nearest one of the repeatedly-scheduled events. Thus, the method is not very easy to use.

As a specific example, the user can set a wake-up alarm that is repeated everyday so that he/she can wake up at a certain time everyday. When the user happens to wake up before the alarm rings, he/she may wish to skip the ringing only on that day and to cancel only the nearest one of the scheduled alarms. As another example, the user can set an alarm that is repeated everyday, so that he/she remembers to take medicine at a certain time everyday. When the user happens to remind himself/herself to take the medicine before the alarm rings, the user may wish to skip the ringing only on that day.

In these situations, according to the method for cancelling the scheduled event described above, the user first performs an operation to input the specific day/time period for which the scheduled event is to be cancelled. Subsequently, the user performs an operation to cause a menu screen to be displayed on the mobile phone and performs an operation to cause a scheduled-event skipping screen to be displayed on the menu screen. After that, on the scheduled-event skipping screen, the user performs an operation to configure a setting indicating whether the scheduled event that is set in advance for the specific day/time period is to be skipped.

As explained above, according to the method for cancelling the scheduled event described above, the user needs to perform the complicated operation to cancel the scheduled event only for the specific day/time period from among the repeatedly-scheduled events. Thus, for example, even if the user wishes to cancel only the nearest one of the repeatedly-scheduled events, the user needs to perform the complicated operation.

### SUMMARY

According to an aspect of an embodiment of the invention, an electronic device includes a memory; and a processor coupled to the memory, wherein the processor executes a process including: storing a condition related to periodically-scheduled events that involve ringing of a device in the memory; judging whether an input operation input via an input unit of the device matches the condition stored in the memory; and when the judging determines that the input operation matches the condition, inhibiting the ringing scheduled at a nearest ringing time from being performed, calculating a ringing time that arrives following the nearest ringing time according to a periodical schedule, and configuring a setting so as to enable the ringing scheduled at the calculated ringing time.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram of a hardware configuration of a mobile phone;

FIG. 2 is a diagram of functional blocks of the mobile phone;

FIG. 3 is a drawing of an example of an alarm list screen;

FIG. 4 is a drawing of an example of an alarm setting screen;

FIG. 5 is a drawing of an example of an alarm setting notification screen;

FIG. 6 is a drawing of an example of a standby screen;

FIG. 7 is a drawing of an example of a sub-menu screen;

FIG. 8 is a drawing of another example of a sub-menu screen;

FIG. 9 is a drawing of an example of a skip setting notification screen;

FIG. 10 is a drawing of an example of a skip cancellation notification screen;

FIG. 11 is a drawing of an example of an already-skipped ringing notification screen;

FIG. 12 is a drawing of an example of a data structure of alarms;

FIG. 13 is a flowchart of a process to calculate a ringing day-of-the-week/time of the nearest one among all the alarms that have already been set and to configure the calculation result into an alarm time controlling unit;

FIG. 14 is a flowchart of a process performed when a user long-presses a key while a standby screen is being displayed;

FIG. 15 is a flowchart of a process performed when the user selects “skip nearest ringing” or “cancel skipping of ringing”, while a sub-menu screen is being displayed; and

FIG. 16 is a flowchart of a process performed when an alarm time controlling unit performs an interrupting process on a processor because a next ringing time has arrived.

### DESCRIPTION OF EMBODIMENT

Preferred embodiment of the present invention will be explained with reference to accompanying drawings. The technical features disclosed herein are not limited to these exemplary embodiments. For example, in the exemplary embodiments described below, a mobile phone will be explained as an example of the electronic device; however, the disclosed technical features are applicable to any electronic device having a repeatedly-scheduling-event function.

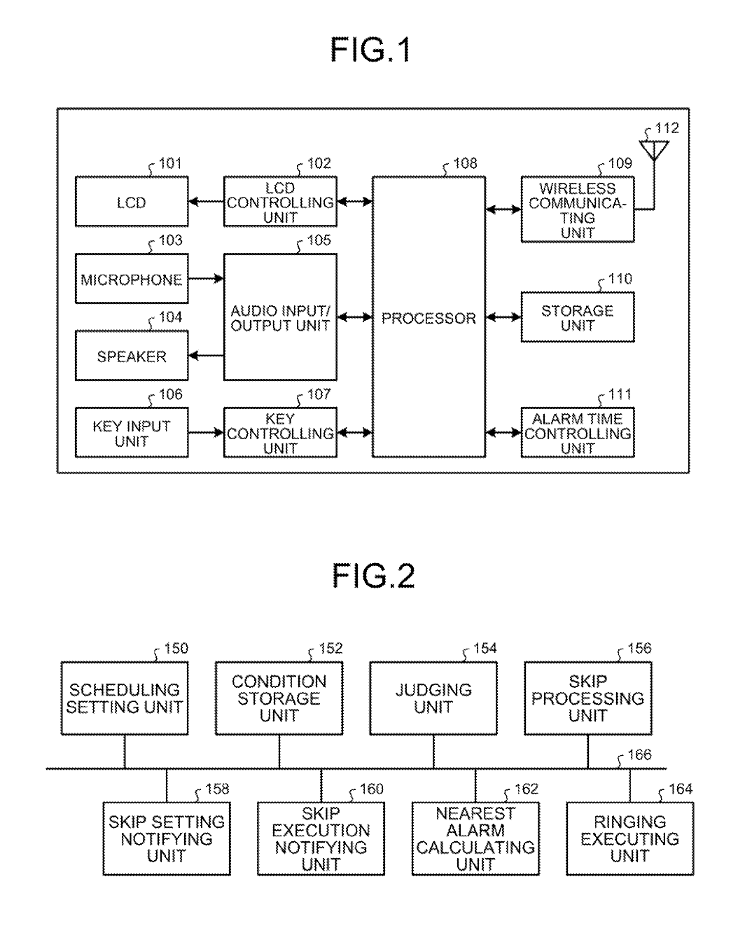

FIG. 1 is a diagram of a hardware configuration of a mobile phone. As depicted in FIG. 1, a mobile phone 100 according to an embodiment includes: a Liquid Crystal Display (LCD) 101; an LCD controlling unit 102; a microphone 103; a speaker 104; and an audio input/output unit 105. Further, the mobile phone 100 includes: a key input unit 106; a key controlling unit 107; a processor 108; a wireless communicating unit 109; a storage unit 110; and an alarm time controlling unit 111.

The LCD 101 is an output interface such as a liquid crystal panel that displays various types of information including text and images. Further, the LCD 101 is also an input interface that has a touch panel function and receives an input of an operation performed by a user. The LCD controlling unit 102 exercises control related to displayed images to be displayed on the LCD 101.

The audio input/output unit 105 is an input/output interface that receives an input of audio via the microphone 103 and that outputs audio via the speaker 104. The key input unit 106 is represented by operation keys with which the mobile phone 100 is provided. The key controlling unit 107 is an input interface that receives an input operation input via the key input unit 106.

The processor 108 is a computation processing unit such as a Central Processing Unit (CPU) that executes various types of computer programs (hereinafter, “programs”) stored in the storage unit 110. The processor 108 controls pieces of hardware in the mobile phone 100, by executing the various types of programs stored in the storage unit 110. The programs executed by the processor 108 do not necessarily have to be stored in the storage unit 110; the programs may be recorded in a distributable storage medium such as a Compact Disc Read-Only Memory (CD-ROM) or a memory medium and may be read from the storage medium and executed. Further, it is also possible to store the programs in a server connected via a network in such a manner that the programs can run on the server, so that services are provided to the mobile phone 100 in response to a request made by the mobile phone 100 connected via a network.

The wireless communicating unit 109 wirelessly communicates various types of data such as audio and text with an electronic device being a communication correspondent via an antenna 112. The wireless communicating unit 109 transmits the various types of data such as audio and text to the electronic device being the communication correspondent via a wireless base station, and also, receives the various types of data from the electronic device being the communication correspondent via a wireless base station.

The storage unit 110 is a storage medium that includes a Read-Only Memory (ROM) storing therein data for implementing various types of functions of the mobile phone 100 or a Random Access Memory (RAM) storing therein various types of programs for implementing the various types of functions.

When a set time set by the processor 108 has arrived, the alarm time controlling unit 111 informs the processor 108 that the set time has arrived by interrupting the processor.

FIG. 2 is a diagram of functional blocks of the mobile phone. As depicted in FIG. 2, the mobile phone 100 includes a scheduling setting unit 150; a condition storage unit 152; a judging unit 154; a skip processing unit 156; a skip setting notifying unit 158; a skip execution notifying unit 160; a nearest alarm calculating unit 162; and a ringing executing unit 164. The scheduling setting unit 150, the condition storage unit 152, the judging unit 154, the skip processing unit 156, the skip setting notifying unit 158, the skip execution notifying unit 160, the nearest alarm calculating unit 162, and the ringing executing unit 164 are connected to one another via a data bus 166.

The scheduling setting unit 150 sets scheduled events by which a process related to ringing of the mobile phone 100 is to be periodically and repeatedly performed. The condition storage unit 152 is a storage unit storing therein a condition related to the execution of a ringing process of the scheduled events set by the scheduling setting unit 150. The condition storage unit 152 is, for example, a data storage unit provided within the storage unit 110.

The judging unit 154 judges whether an input operation input via the LCD 101 or the key input unit 106 while a standby image is being displayed on the LCD 101 matches the condition stored in the condition storage unit 152. The judging unit 154 also judges whether the form of the mobile phone 100 matches the condition stored in the condition storage unit 152 at a time when the scheduled ringing process is to be executed. The details of the judging unit 154 will be described later.

When the judging unit 154 determines that the input operation matches the condition or that the form of the mobile phone 100 matches the condition, the skip processing unit 156 sets the ringing process of only the nearest scheduled event to be “non-execution”, from among the repeatedly-scheduled events set by the scheduling setting unit 150. Further, when the judging unit 154 determines that an input operation matches the condition while the ringing process of only the nearest scheduled event is set to be “non-execution” from among the repeatedly-scheduled events set by the scheduling setting unit 150, the skip processing unit 156 cancels the “non-execution” state of the nearest scheduled event that was previously set to be “non-execution”. Further, when it is determined that the form of the mobile phone 100 matches the condition while the ringing process of only the nearest scheduled event is set to be “non-execution” from among the repeatedly-scheduled events set by the scheduling setting unit 150, the skip processing unit 156 cancels the “non-execution” state of the nearest scheduled event that was previously set to be “non-execution”. Further, when the judging unit 154 determines that an input operation matches the condition, the skip processing unit 156 inhibits the ringing scheduled at the nearest ringing time from being performed, calculates a ringing time that arrives following the nearest ringing time according to the periodical schedule, and configures a setting so as to enable the ringing scheduled at the calculated ringing time. The details of the skip processing unit 156 will be described later.

When the skip processing unit 156 has set the ringing process of the nearest scheduled event to be non-execution from among the repeatedly-scheduled events, the skip setting notifying unit 158 displays a skip setting notification on the LCD 101 to notify the date/time of the scheduled event set to be non-execution and to notify that the ringing process of the scheduled event is set to be non-execution. Further, when the skip processing unit 156 has cancelled the non-execution state of the nearest scheduled event, the skip setting notifying unit 158 displays a skip cancellation notification on the LCD 101 to notify that a ringing process will be executed on the scheduled date/time.

When the ringing process of the nearest scheduled event set to be non-execution by the skip processing unit 156 from among the repeatedly-scheduled events is actually skipped, the skip execution notifying unit 160 displays a skip notification on the LCD 101 to notify that the ringing process has been skipped.

The nearest alarm calculating unit 162 performs a process of calculating the nearest day-of-the-week/time at which the alarm is to ring, based on the setting details of all the alarms and configuring the calculated day-of-the-week/time into the alarm time controlling unit 111. The ringing executing unit 164 causes the mobile phone 100 to ring, if the nearest scheduled event from among the repeatedly-scheduled events set by the scheduling setting unit 150 is not set to be non-execution by the skip processing unit 156. For example, the ringing executing unit 164 causes the mobile phone 100 to ring, by activating a vibrator with which the mobile phone 100 is provided so as to make the mobile phone 100 vibrate or by causing the mobile phone 100 to output audio via the speaker 104.

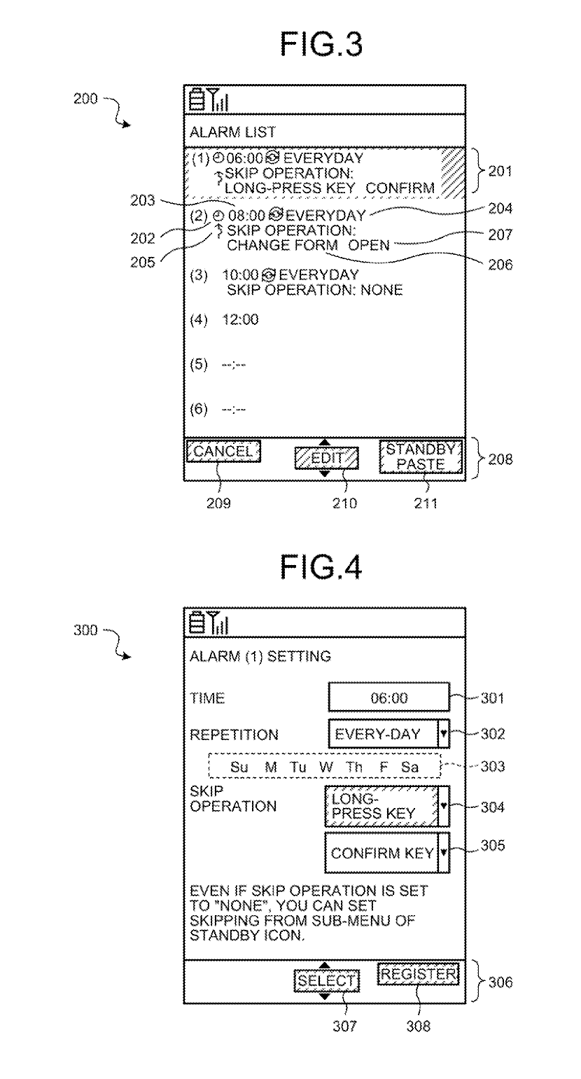

FIG. 3 is a drawing of an example of an alarm list screen. As depicted in FIG. 3, an alarm list screen 200 is displayed on the LCD 101, when an alarm function is activated from a menu or the like. The alarm list screen 200 displays details of each of the alarms in a list format. The details of each of the alarms include: an alarm setting icon 202, a ringing time 203, a repetition setting 204, a skip setting icon 205, and skip operation settings 206 and 207. Listings the quantity of which is equal to the number of alarms are displayed so as to indicate the details of the alarms. Further, an alarm 201, which is currently selected, is highlighted or the like, so as to indicate that the alarm is selected.

The alarm setting icon 202 is displayed if the corresponding alarm is in an enabled state and is not displayed if the corresponding alarm is in a disabled state. The ringing time 203 indicates a time if a ringing time is set and displays, for example, “--:--” if a ringing time is not set. The repetition setting 204 indicates the details of a repetition setting if a repetition setting is configured, but is not displayed if no repetition setting is configured.

The skip setting icon 205 is displayed if the corresponding alarm is set to skip and is not displayed if the corresponding alarm is not set to skip. The skip operation settings 206 and 207 indicate the details of skip operation settings if skip operation settings are configured, but are not displayed if no skip operation settings are configured.

A “set/cancel” key 209, an “edit” key 210, and a “standby paste” key 211 are displayed in a key guidance display section 208. The “set/cancel” key 209 is displayed as “cancel”, if the alarm 201 currently selected is in a state where information about the time or the like is set, and also, is in an enabled state. In contrast, the “set/cancel” key 209 is displayed as “set”, if the alarm 201 is in a disabled state. If no information is set for the alarm 201 currently selected, the “set/cancel” key 209 is not displayed. When the user presses the “cancel” key 209, the currently selected alarm is disabled, and the alarm setting icon 202 is erased. When the user presses the “set” key 209, the currently selected alarm is enabled, and the alarm setting icon 202 is displayed. The “edit” key 210 is displayed at all times. When the user presses the “edit” key 210, an alarm setting screen, which is depicted in FIG. 4 and explained later, is displayed.

The “standby paste” key 211 is displayed at all times. When the user presses the “standby paste” key 211, a shortcut to the currently selected alarm 201 is pasted onto the standby screen, as depicted in FIG. 6 and explained later.

FIG. 4 is a drawing of an example of the alarm setting screen. A ringing time 301, a repetition setting 302, a repetition day-of-the-week setting 303, and skip operation settings 304 and 305 are displayed on an alarm setting screen 300. As the ringing time 301, a time at which the alarm is to ring is set. When the repetition setting 302 is selected, a pull-down list is displayed, so that the user selects a desired option from the pull-down list. Examples of selectable options include “none”, “everyday”, “specified day of the week”, “weekdays”, and “weekends/holidays”. The repetition day-of-the-week setting 303 is in an enabled state, if the “specified day of the week” is selected as the repetition setting 302. In all the other situations, the repetition day-of-the-week setting 303 is in a disabled state (i.e., grayed out). When the repetition day-of-the-week setting 303 is in an enabled state, the user can select a day of the week on which he/she wishes to have the alarm ring from among Sunday through Saturday.

When the skip operation setting 304 is selected, a pull-down list is displayed, so that the user selects a desired option from the pull-down list. Examples of selectable options include “none”, “long-press key”, and “change form”. The skip operation setting 305 supplements the skip operation setting 304. If “long-press key” or “change form” is selected as the skip operation setting 304, the skip operation setting 305 is in an enabled state. On the contrary, if “none” is selected as the skip operation setting 304, the skip operation setting 305 is in a disabled state (i.e., grayed out).

When the “long-press key” is selected as the skip operation setting 304, examples of selectable options include “0-9”, “*”, “#”, “menu”, “up/down/left/right”, “on hook”, “off hook”, and “side key”. It is possible to use any of the various types of keys installed on the mobile phone 100 in the setting.

When the “change form” is selected as the skip operation setting 304, examples of selectable options include “open”, “close”, “slide to close”, “90° to the left”, and “90° to the right”. In the setting, it is possible to use any of various types of forms which the mobile phone 100 can take. The options “90° to the left” and “90° to the right” denote rotation angles of the main display. It is possible to associate each of the selectable options in the skip operation setting 305 with only one alarm. Thus, any selectable options that have already been associated with other alarms are grayed out or are not displayed, so that the user is not able to select those options.

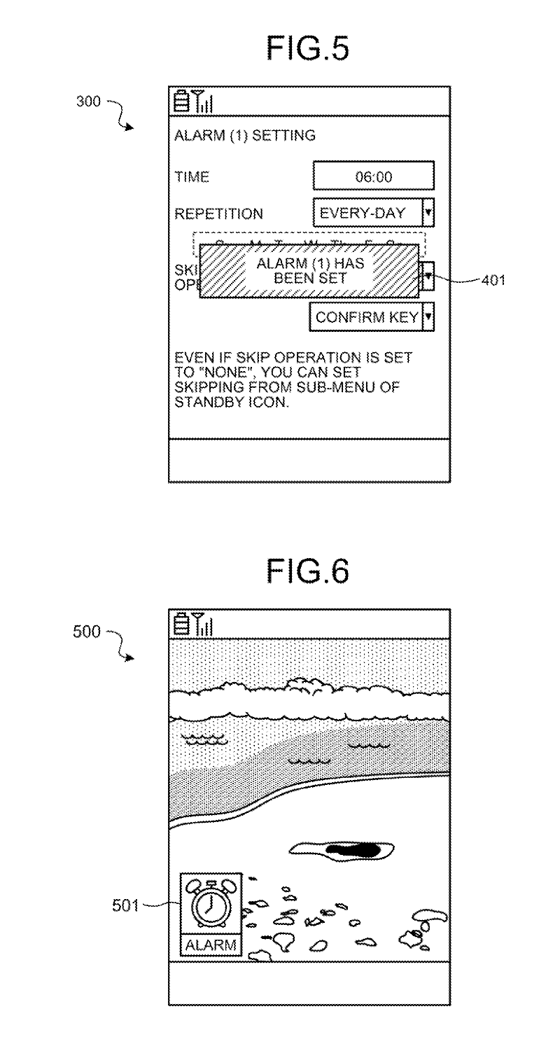

A “select” key 307 and a “register” key 308 are displayed in a key guidance display section 306. When the user presses the “register” key 308, the details such as the ringing time 301 to the skip operation setting 305 that are displayed are registered into a database, and an alarm setting notification screen depicted in FIG. 5 and explained later is displayed so as to inform the user that the information has been registered. When the display of the alarm setting notification screen has timed out or when the user presses any key before the display times out, the alarm list screen depicted in FIG. 3 is displayed.

FIG. 5 is a drawing of an example of the alarm setting notification screen. As depicted in FIG. 5, when the user sets a repeatedly-scheduled event, the details such as the ringing time 301 to the skip operation setting 305 that are displayed are registered into the database, and an alarm setting notification screen 401 is displayed on the alarm setting screen 300. Information indicating that a repeatedly-scheduled event to ring an alarm has been set is displayed on the alarm setting notification screen 401.

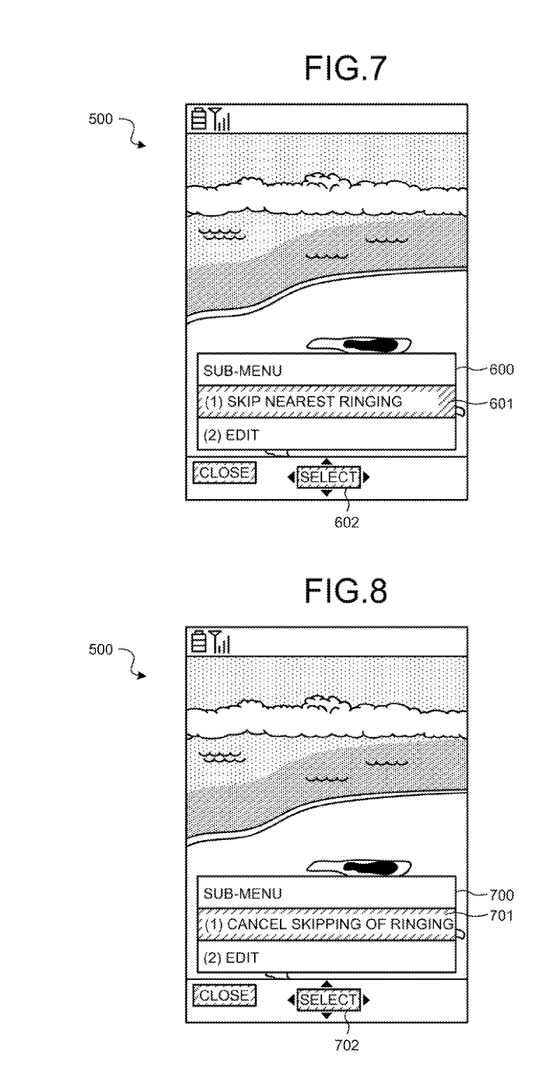

FIG. 6 is a drawing of an example of a standby screen. On a standby screen 500, an alarm icon 501 is displayed, if the “standby paste” key 211 was pressed while the alarm list screen 200 depicted in FIG. 3 was being displayed. The alarm icon 501 indicates which alarm corresponds to this icon by using text. When the user selects the alarm icon 501 by touching the alarm icon 501 displayed on the LCD 101 or by pressing the key input unit 106, a sub-menu screen depicted in FIG. 7 or FIG. 8 (explained later) is displayed.

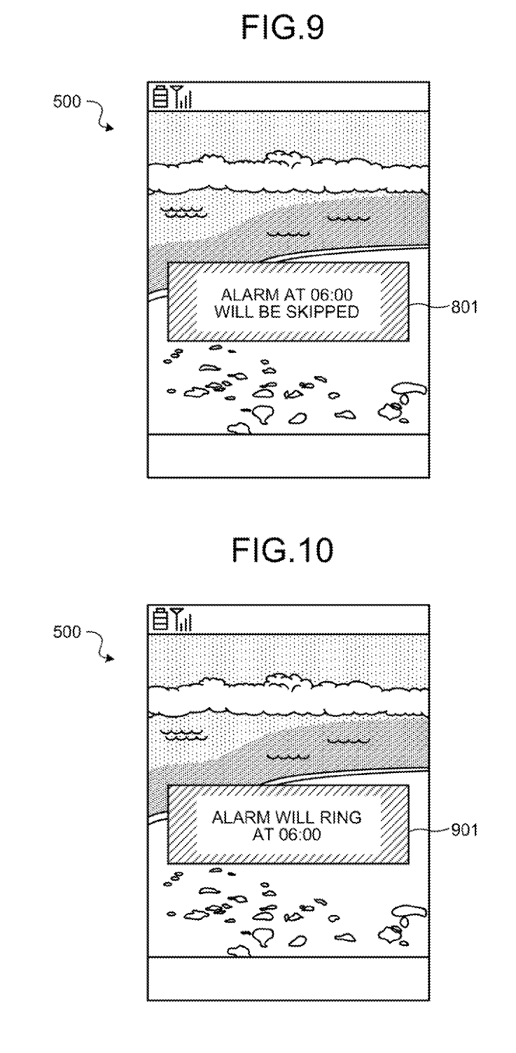

Further, in the situation where the “long-press key” is selected as the skip operation setting 304, when the key set in the skip operation setting 305 is long-pressed, the corresponding alarm is set to skip if the skipping of the alarm is currently in a cancelled state, so that a skip setting notification screen depicted in FIG. 9 and explained later is displayed. On the contrary, in the situation where the “long-press key” is selected as the skip operation setting 304, when the key set in the skip operation setting 305 is long-pressed, the skipping of the corresponding alarm is cancelled if the alarm is currently set to skip, so that a skip cancellation notification screen depicted in FIG. 10 and explained later is displayed.

FIGS. 7 and 8 are drawings of examples of sub-menu screens. The sub-menu screen depicted in FIG. 7 is displayed when the selected alarm is not set to skip. The sub-menu screen depicted in FIG. 8 is displayed when the selected alarm is set to skip. As depicted in FIG. 7, if an item “skip nearest ringing” 601 is selected on a sub-menu screen 600 by pressing a “select” key 602, the alarm is set to skip so that a skip setting notification screen depicted in FIG. 9 and explained later is displayed. In contrast, as depicted in FIG. 8, if an item “cancel skipping of ringing” 701 is selected on a sub-menu screen 700 by pressing a “select” key 702, the skipping of the alarm is canceled so that a skip cancellation notification screen depicted in FIG. 10 and explained later is displayed.

FIG. 9 is a drawing of an example of the skip setting notification screen. FIG. 10 is a drawing of an example of the skip cancellation notification screen. On the sub-menu screen 600 depicted in FIG. 7, if the item “skip nearest ringing” 601 is selected, a skip setting notification screen 801 is displayed, as depicted in FIG. 9. In contrast, on the sub-menu screen 700 depicted in FIG. 8, if the item “cancel skipping of ringing” 701 is selected, a skip cancellation notification screen 901 is displayed, as depicted in FIG. 10.

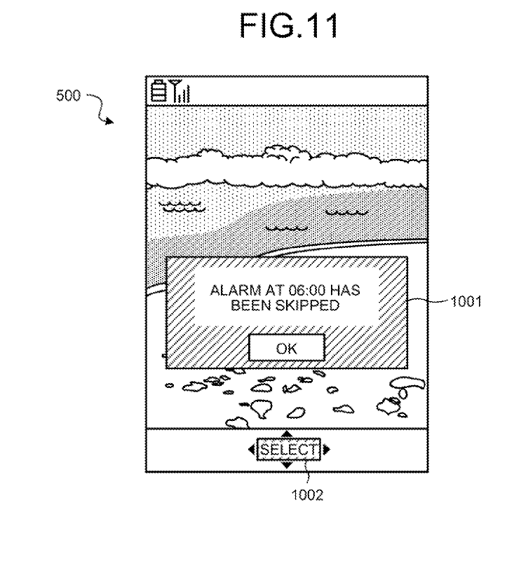

FIG. 11 is a drawing of an example of an already-skipped ringing notification screen. As depicted in FIG. 11, an already-skipped ringing notification screen 1001 is displayed on a standby screen 500, when the ringing time of an alarm that is set to skip has arrived and the ringing has been skipped. There is a possibility that the already-skipped ringing notification screen 1001 may be displayed while the user is not operating the mobile phone 100. Thus, the screen is not subject to a time-out transition, but keeps being displayed until the user presses a “select” button 1002 or an on-hook button.

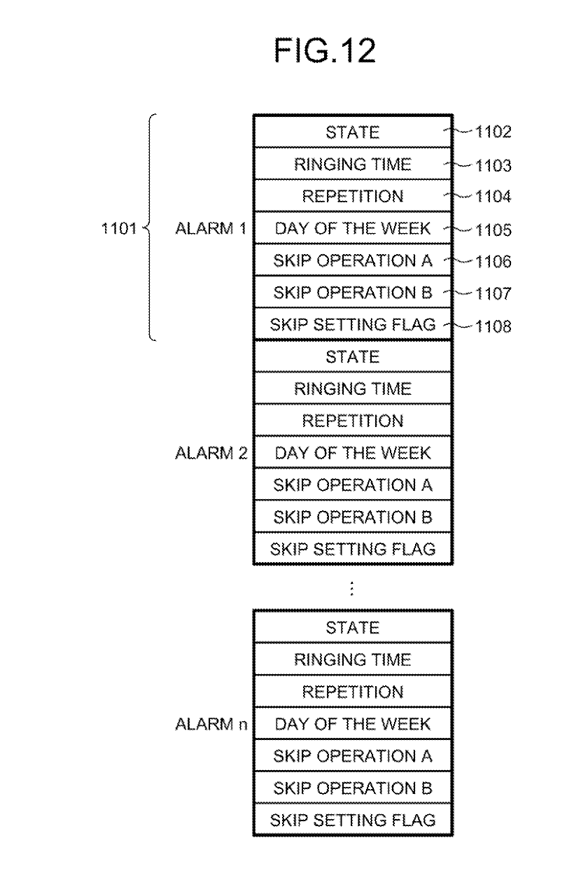

FIG. 12 is a drawing of an example of a data structure of alarms. As depicted in FIG. 12, an alarm data structure element 1101 includes a state 1102, a ringing time 1103, a repetition 1104, days of the week 1105, a skip operation A 1106, a skip operation B 1107, and a skip setting flag 1108. The alarm data structure element 1101 is set for each of different types of alarms. The alarm data structure elements 1101 the quantity of which is equal to the number of alarms are stored in the storage unit 110.

The state 1102 indicates the state of the corresponding alarm (i.e., “enabled”, “disabled”, or “not set”). If the state 1102 of the alarm is “enabled”, the alarm rings at the time set as the ringing time 1103. In contrast, if the state 1102 of the alarm is “disabled” or “not set”, the alarm does not ring. Further, the state 1102 is in conjunction with the alarm setting icon 202. If the state 1102 of the alarm is “enabled”, the alarm setting icon 202 is displayed. On the contrary, if the state 1102 of the alarm is “disabled” or “not set”, the alarm setting icon 202 is not displayed.

The ringing time 1103 indicates a time at which the alarm is to ring and is displayed on the LCD 101 as the ringing times 203 and 301. The repetition 1104 indicates a setting of whether the alarm is to be repeated or not. Examples of types of the repetition 1104 include “none”, “everyday”, “specified day of the week”, “weekdays”, and “weekends/holidays”. If the repetition 1104 is set to “none”, the alarm rings only once at the nearest ringing time 1103. If the repetition 1104 is set to “everyday”, the alarm rings repeatedly at the ringing time 1103 everyday. If the repetition 1104 is set to “specified day of the week”, the alarm rings repeatedly at the ringing time 1103 on the day of the week specified in the day of the week 1105. If the repetition 1104 is set to “weekdays”, the alarm rings repeatedly at the ringing time 1103 on weekdays. If the repetition 1104 is set to “weekends/holidays”, the alarm rings repeatedly at the ringing time 1103 on weekends and holidays. The repetition 1104 is displayed on the LCD 101 as the repetition settings 204 and 302.

The day of the week 1105 is in an enabled state if the repetition 1104 is set to “specified day of the week”, and the user can set the day of the week on which the alarm is to ring. The day of the week 1105 is displayed as the repetition day-of-the-week setting 303. The skip operation A 1106 is used for setting what operation may be performed by the user to skip the nearest ringing of the corresponding alarm.

Examples of types of skip operation A 1106 include “none”, “long-press key”, and “change form”. If the type of the skip operation A 1106 is set to “none”, the user is able to set the alarm to skip only from the sub-menu screen depicted in FIG. 7. As another example, if the type of the skip operation A 1106 is set to “long-press key”, the user is able to set the alarm to skip by long-pressing the key set in the skip operation B 1107 while the standby screen depicted in FIG. 6 is being displayed or from the sub-menu screen depicted in FIG. 7. As yet another example, if the type of the skip operation A 1106 is set to “change form”, the alarm skips if the mobile phone is in the form of the terminal set in the skip operation B 1107 when the ringing time arrives or the user is also able to set the alarm to skip from the sub-menu screen depicted in FIG. 7. The skip operation A 1106 is displayed on the LCD 101 as the skip operation settings 206 and 304.

The skip operation B 1107 is in an enabled state if the skip operation A 1106 is set to “long-press key” or “change form” and is used for setting a specific operation corresponding to the skip operation A 1106. When the skip operation A 1106 is set to “long-press key”, it is possible to use, in the setting, any of the various type of keys installed on the mobile phone 100, such as “0-9”, “*”, “#”, “menu”, “up/down/left/right”, “on hook”, “off hook”, and “side key”. When the skip operation A 1106 is set to “change form”, it is possible to use, in the setting, any of various types of forms which the mobile phone 100 can take, including “open”, “close”, “slide to close”, “90° to the left”, and “90° to the right”. The skip operation B 1107 is displayed on the LCD 101 as the skip operation settings 207 and 305.

The skip setting flag 1108 indicates the setting of whether the nearest ringing of the corresponding alarm is to be skipped or not. Examples of types of the skip setting flag 1108 include “on” and “off”. The skip setting flag is “on” if the alarm is set to skip and is “off” if the alarm is not set to skip. While the skip setting flag 1108 is “on”, the skip setting icon 205 is displayed. On the contrary, while the skip setting flag 1108 is “off”, the skip setting icon 205 is not displayed.

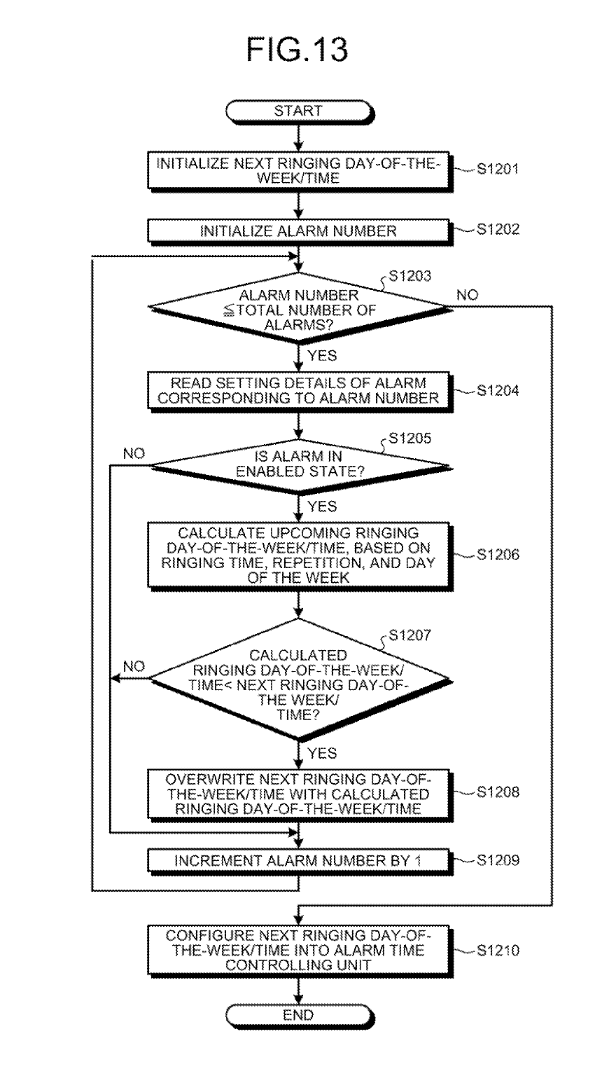

FIG. 13 is a flowchart of a process to calculate a ringing day-of-the-week/time of the nearest one among all the alarms that have already been set and to configure the calculation result into the alarm time controlling unit. The process depicted in FIG. 13 is performed when it is implemented to update the next ringing time, e.g., when the “set/cancel” key 209 is pressed while the alarm list screen depicted in FIG. 3 is being displayed, or when the “register” key 308 is pressed while the alarm setting screen depicted in FIG. 4 is being displayed. As another example, the process depicted in FIG. 13 is performed when it is implemented to update the next ringing time, e.g., when the skip operation setting 304 is set to “long-press key”, and also, the key set in the skip operation setting 305 is long-pressed while the standby screen depicted in FIG. 6 is being displayed. As yet another example, the process depicted in FIG. 13 is performed when it is implemented to update the next ringing time, e.g., when the item “skip nearest ringing” 601 is selected while the sub-menu screen depicted in FIG. 7 is being displayed, or when the item “cancel skipping of ringing” 701 is selected while the sub-menu screen depicted in FIG. 8 is being displayed. As yet another example, the process depicted in FIG. 13 is performed when it is implemented to update the next ringing time, e.g., when the alarm rings upon arrival of the alarm set time or when the ringing is skipped as depicted in FIG. 11.

First, the nearest alarm calculating unit 162 initializes the next ringing day-of-the-week and the next ringing time by assigning the maximum values thereto (step S1201). Further, the nearest alarm calculating unit 162 initializes the alarm number (step S1202). The next ringing day-of-the-week, the next ringing time, and the alarm number are internal variables that are used in the process depicted in FIG. 13.

The nearest alarm calculating unit 162 judges whether “the alarm number≦the total number of alarms” is satisfied (step S1203). If it is determined that “the alarm number≦the total number of alarms” is satisfied (step S1203: Yes), the nearest alarm calculating unit 162 reads the details of the alarm corresponding to the alarm number so as to signify that there is at least one alarm that has been set and has not yet been processed (step S1204).

Subsequently, the nearest alarm calculating unit 162 judges whether the value expressing the state of the alarm in the read alarm details indicates that the alarm is in an enabled state (step S1205). If it is determined that the alarm is in an enabled state (step S1205: Yes), the nearest alarm calculating unit 162 calculates an upcoming ringing day-of-the-week/time, based on the ringing time, the repetition, and the day of the week (step S1206).

The nearest alarm calculating unit 162 then judges whether “the calculated ringing day-of-the-week/time<the next ringing day-of-the-week/time” is satisfied (step S1207). When the alarm number of the alarm is 1, the next ringing day-of-the-week/time is set to the maximum value. In contrast, when the alarm number of the alarm is 2 or larger, the next ringing day-of-the-week/time is set to the nearest ringing day-of-the-week/time among the ringing days of the week and times, which is calculated based on the setting details of the alarms that have already been processed up to the point in time immediately prior. If it is determined that “the calculated ringing day-of-the-week/time<the next ringing day-of-the-week/time” is satisfied (step S1207: Yes), the nearest alarm calculating unit 162 overwrites the next ringing day-of-the-week/time with the calculated ringing day-of-the-week/time (step S1208). As a result, the nearest ringing day-of-the-week/time is set as the next ringing day-of-the-week/time.

After that, the nearest alarm calculating unit 162 increments the alarm number (step S1209), and the process returns to step S1203. Also, if it is determined at step S1205 that the alarm is not in an enabled state (step S1205: No), the nearest alarm calculating unit 162 increments the alarm number (step S1209), and the process returns to step S1203. Also, if it is determined at step S1207 that “the calculated ringing day-of-the-week/time<the next ringing day-of-the-week/time” is not satisfied (step S1207: No), the nearest alarm calculating unit 162 increments the alarm number (step S1209), and the process returns to step S1203.

In contrast, if it is determined that “the alarm number≦the total number of alarms” is not satisfied (step S1203: No), the nearest alarm calculating unit 162 configures the next ringing day-of-the-week/time into the alarm time controlling unit 111 (step S1210). As a result, the nearest ringing time found in the processing loop at steps S1203 through S1209 is configured into the alarm time controlling unit 111.

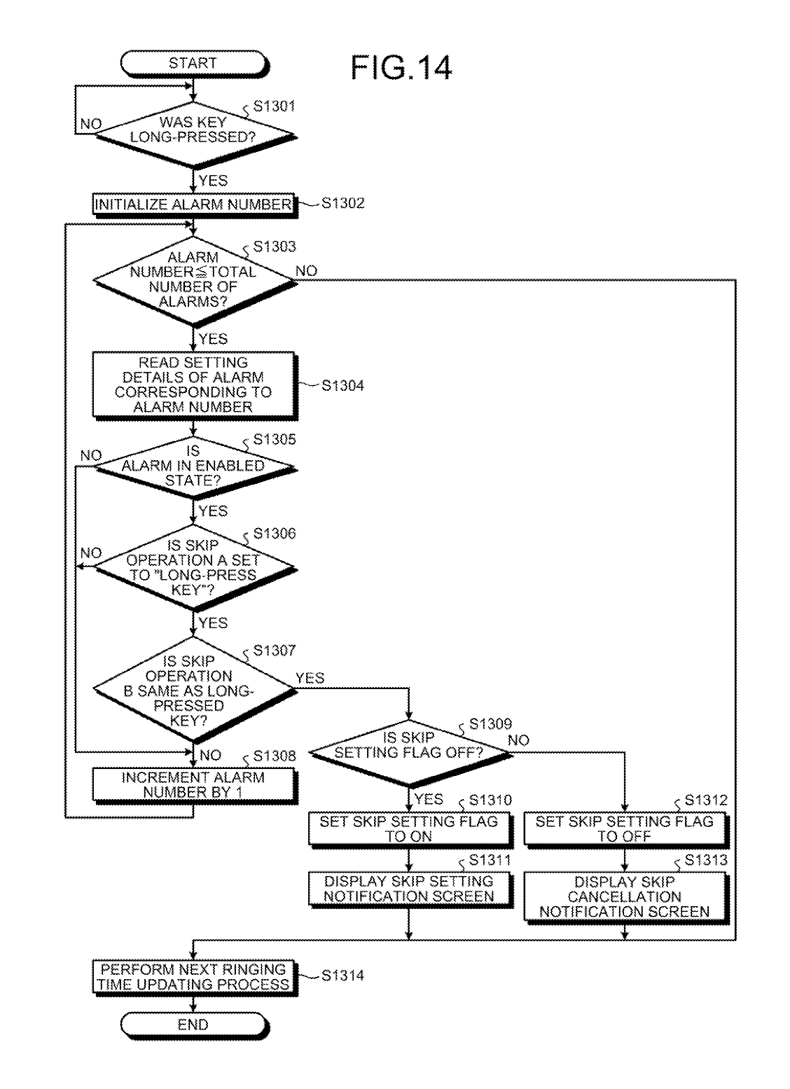

FIG. 14 is a flowchart of a process performed when the user long-presses a key while a standby screen is being displayed. As depicted in FIG. 14, the judging unit 154 first judges whether a key was long-pressed (step S1301). If it is determined that a key was long-pressed (step S1301: Yes), the judging unit 154 initializes the alarm number (step S1302). The alarm number is an internal variable used in the process depicted in FIG. 14.

The judging unit 154 judges whether “the alarm number≦the total number of alarms” is satisfied (step S1303). If it is determined that “the alarm number the total number of alarms” is satisfied (step S1303: Yes), the judging unit 154 reads the setting details of the alarm corresponding to the alarm number (step S1304).

The judging unit 154 then judges whether the alarm is in an enabled state (step S1305). If it is determined that the alarm is in an enabled state (step S1305: Yes), the judging unit 154 judges whether the skip operation A is set to “long-press key” (step S1306). If it is determined that the skip operation A is set to “long-press key” (step S1306: Yes), the judging unit 154 judges whether the skip operation B is set to the same key as the key that was long-pressed (step S1307).

If it is determined that the skip operation B is not set to the same key as the long-pressed key (step S1307: No), the judging unit 154 increments the alarm number (step S1308), and the process returns to step S1303. Also, if it is determined that the alarm is not in an enabled state (step S1305: No), the judging unit 154 increments the alarm number (step S1308), and the process returns to step S1303. Also, if it is determined that the skip operation A is not set to “long-press key” (step S1306: No), the judging unit 154 increments the alarm number (step S1308), and the process returns to step S1303.

On the contrary, if it is determined that the skip operation B is set to the same key as the long-pressed key (step S1307: Yes), the skip processing unit 156 judges whether the skip setting flag is “off” (step S1309). If it is determined that the skip setting flag is “off” (step S1309: Yes), the skip processing unit 156 sets the skip setting flag to “on” (step S1310). The skip setting notifying unit 158 displays the skip setting notification screen 801 (step S1311).

On the contrary, if it is determined that the skip setting flag is not “off” (step S1309: No), the skip processing unit 156 sets the skip setting flag to “off” (step S1312). The skip setting notifying unit 158 displays the skip cancellation notification screen 901 (step S1313).

In contrast, if it is determined that “the alarm number≦the total number of alarms” is not satisfied (step S1303: No), the nearest alarm calculating unit 162 performs the next ringing time updating process depicted in FIG. 13 (step S1314). In addition, the nearest alarm calculating unit 162 performs the next ringing time updating process depicted in FIG. 13, also after performing the process at step S1311 or S1313 (step S1314).

As explained above, in the processing loop at steps S1303 through S1308, the search is conducted to check to see if the pressed key is used in the skip setting, and if the pressed key is not the key specified in the setting (step S1307: No), the skip setting/cancellation process is not performed. On the contrary, in the processing loop at steps S1303 through S1308, the search is conducted to check to see if the pressed key is used in the skip setting, and if the pressed key is the key specified in the setting (step S1307: Yes), the skip setting process or the skip cancellation process is performed.

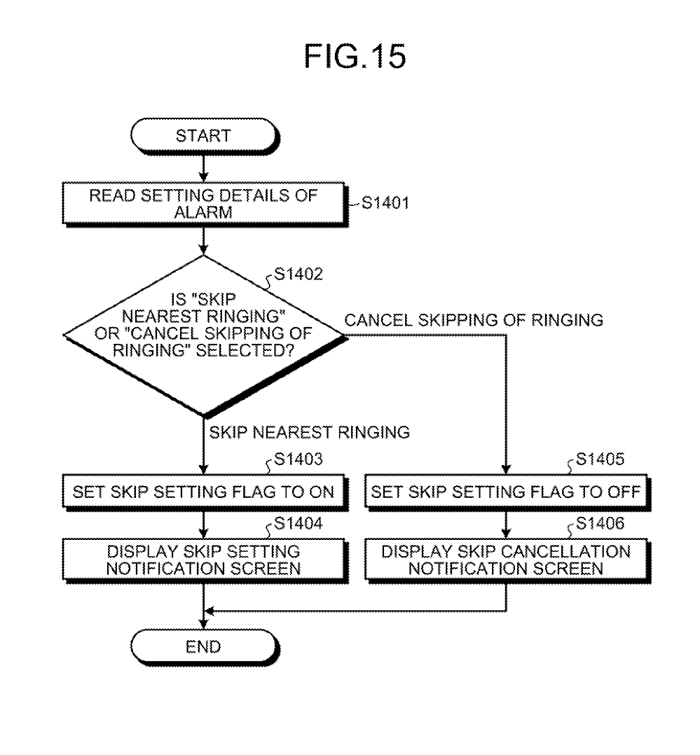

FIG. 15 is a flowchart of a process performed when the user selects “skip nearest ringing” or “cancel skipping of ringing”, while a sub-menu screen is being displayed. As depicted in FIG. 15, the judging unit 154 first reads the setting details of the alarm (step S1401). Subsequently, the judging unit 154 judges whether the item “skip nearest ringing” 601 is selected or the item “cancel skipping of ringing” 701 is selected (step S1402).

If it is determined that the item “skip nearest ringing” 601 was selected, the skip processing unit 156 sets the skip setting flag to “on” (step S1403). The skip setting notifying unit 158 displays the skip setting notification screen 801 (step S1404).

In contrast, if it is determined that the item “cancel skipping of ringing” 701 was selected, the skip processing unit 156 sets the skip setting flag to “off” (step S1405). The skip setting notifying unit 158 displays the skip cancellation notification screen 901 (step S1406).

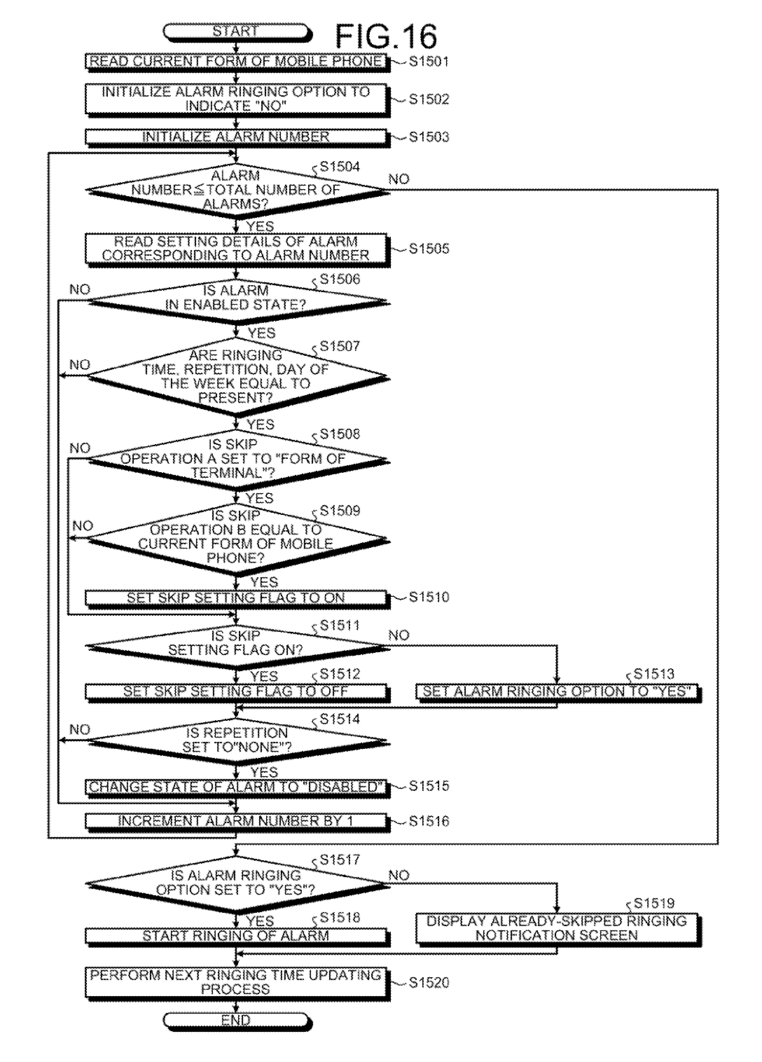

FIG. 16 is a flowchart of a process performed when the alarm time controlling unit performs an interrupting process on the processor because a next ringing time has arrived. First, the judging unit 154 reads the current form of the mobile phone 100 (step S1501). Subsequently, the judging unit 154 initializes the alarm ringing option so as to indicate “No” (step S1502). Also, the judging unit 154 initializes the alarm number (step S1503). The alarm ringing option and the alarm number are internal variables used in the process depicted in FIG. 16.

The judging unit 154 judges whether “the alarm number≦the total number of alarms” is satisfied (step S1504). If it is determined that “the alarm number the total number of alarms” is satisfied (step S1504: Yes), the judging unit 154 reads the setting details of the alarm corresponding to the alarm number (step S1505).

The judging unit 154 judges whether the alarm is in an enabled state (step S1506). If it is determined that the alarm is in an enabled state (step S1506: Yes), the judging unit 154 judges whether the ringing time, the repetition, and the day of the week are equal to the present (step S1507).

If it is determined that the ringing time, the repetition, and the day of the week are equal to the present (step S1507: Yes), the judging unit 154 judges whether the skip operation A is set to “form of terminal” (step S1508). If it determined that the skip operation A is set to “form of terminal” (step S1508: Yes), the judging unit 154 judges whether the skip operation B is equal to the current form of the mobile phone 100 (step S1509).

If it is determined that the skip operation B is equal to the current form of the mobile phone 100 (step S1509: Yes), the skip processing unit 156 sets the skip setting flag to “on” (step S1510). The skip processing unit 156 then judges whether the skip setting flag is set to “on” (step S1511). Also, if it is determined that the skip operation A is not set to “form of terminal” (step S1508: No), the skip processing unit 156 judges whether the skip setting flag is set to “on” (step S1511). Also, if it is determined that the skip operation B is not equal to the current form of the mobile phone 100 (step S1509: No), the skip processing unit 156 judges whether the skip setting flag is set to “on” (step S1511).

If it is determined that the skip setting flag is set to “on” (step S1511: Yes), the skip processing unit 156 sets the skip setting flag to “off” (step S1512). On the contrary, if it determined that the skip setting flag is not set to “on” (step S1511: No), the skip processing unit 156 sets the alarm ringing option to “Yes” (step S1513).

After the process at step S1512 or step S1513 is performed, the judging unit 154 judges whether the repetition is set to “none” (step S1514). If it is determined that the repetition is set to “none” (step S1514: Yes), the judging unit 154 changes the state of the alarm so as to be in a “disabled” state (step S1515). The judging unit 154 increments the alarm number (step S1516), and the process returns to step S1504. Also, if it is determined that the alarm is not in an enabled state (step S1506: No), the judging unit 154 increments the alarm number (step S1516), and the process returns to step S1504. Also, if it is determined that the ringing time, the repetition, and the day of the week are not equal to the present (step S1507: No), the judging unit 154 increments the alarm number (step S1516), and the process returns to step S1504. Also, if it is determined that the repetition is not set to “none” (step S1514: No), the judging unit 154 increments the alarm number (step S1516), and the process returns to step S1504.

If it is determined that “the alarm number the total number of alarms” is not satisfied (step S1504: No), the ringing executing unit 164 judges whether the alarm ringing option is set to “Yes” (step S1517). If it is determined that the alarm ringing option is set to “Yes” (step S1517: Yes), the ringing executing unit 164 starts the ringing of the alarm (step S1518).

On the contrary, if it is determined that the alarm ringing option is not set to “Yes” (step S1517: No), the skip execution notifying unit 160 displays the already-skipped ringing notification screen 1001 (step S1519). After the process at step S1518 is performed or after the process at step S1519 is performed, the nearest alarm calculating unit 162 performs the next ringing time updating process depicted in FIG. 13 (step S1520).

As explained above, in the processing loop at steps S1504 through S1516, the settings of all the alarms are referenced so that, if the skip setting flags 1108 of all the alarms are set to “on”, the ringing is not performed, and the already-skipped ringing notification screen is displayed. If there is at least one alarm that is set to ring, the ringing of the alarm is performed. The judgment of whether the ringing is skipped according to the form of the terminal is made based on the form of the terminal at the alarm ringing time. Thus, the judgments related to the skip operation A and the skip operation B are made within the processing loop at steps S1504 through S1516.

As explained above, when the mobile phone according to the present embodiment is used, it is possible to cancel only the nearest one of the repeatedly-scheduled events, by performing the simple operation. In other words, the mobile phone according to the present embodiment is configured so that it is possible to cancel only the nearest one of the repeatedly-scheduled events, by performing the simple operation, for example, the operation to long-press the key set in advance, while the standby image is being displayed on the LCD 101. Further, the mobile phone according to the present embodiment is configured so that it is possible to cancel only the nearest one of the repeatedly-scheduled events, by performing the simple operation on the sub-menu displayed when the user selects the scheduling icon displayed on the standby image while the standby image is being displayed on the LCD 101. Further, the mobile phone according to the present embodiment is configured so that it is possible to cancel only the nearest one of the repeatedly-scheduled events, by performing the simple operation such as to cause the form of the mobile phone to match the condition set in advance.

Accordingly, unlike the conventional technique, the mobile phone according to the present embodiment does not require any complicated operations to cancel the scheduled event only for a specific day or a specific time period from among the repeatedly-scheduled events. As a result, when the mobile phone according to the present embodiment is used, for example, when the user sets a wake-up alarm that is repeated everyday so that he/she wakes up at a certain time everyday and if the user happens to wake up before the alarm rings, he/she is able to cancel the ringing of the alarm only for the nearest one time (i.e., only on that day) by performing the simple operation. As another example, when the mobile phone according to the present embodiment is used, for example, when the user sets an alarm that is repeated everyday so that he/she remembers to take medicine at a certain time everyday and if the user happens to remind himself/herself to take the medicine before the alarm rings, he/she is able to cancel the ringing of the alarm only for the nearest one time (i.e., only on that day) by performing the simple operation.

Further, when the mobile phone according to the present embodiment is used, it is possible to cancel the non-execution state of the nearest scheduled event that was previously set to be non-execution, by performing the simple operation, for example, the operation to long-press the key set in advance, while the standby image is being displayed on the LCD 101. Accordingly, in the situation where, for example, the user cancels the nearest scheduled alarm by performing a wrong operation, the user is able to undo the cancellation of the nearest scheduled alarm by performing the simple operation.

Further, the mobile phone according to the present embodiment is configured so that, when a plurality of types of repeatedly-scheduled events are arranged, it is possible to set a different condition related to the execution of the ringing process for each of the plurality of scheduled events. Thus, it is possible to appropriately perform the process to cancel the nearest scheduled event for each of the scheduled events.

Further, the mobile phone according to the present embodiment is configured so that, when the ringing process of the nearest scheduled event is set to be non-execution, the skip setting notification is displayed on the LCD 101 so as to indicate the date/time of the scheduled event set to be non-execution and to indicate that the ringing process of the scheduled event is set to be non-execution. Thus, it is possible to prevent the user from cancelling the nearest scheduled event by mistake.

Further, the mobile phone according to the present embodiment is configured so that, when the ringing process of the nearest scheduled event has actually been skipped, the skip notification is displayed on the LCD 101 so as to indicate that the ringing process has been skipped. Thus, it is possible to inform the user that the nearest scheduled event has been skipped.

The exemplary embodiments have been explained by primarily describing the mobile phone and the scheduling controlling method; however, the exemplary embodiments are not limited to these examples. It is possible to realize the same functions as those in the exemplary embodiments above by causing a computer to execute a scheduling control computer program (hereinafter, “scheduling control program”) prepared in advance. More specifically, the scheduling control program causes an electronic device to perform the process of setting scheduled events by which a process related to ringing of a device is to be periodically and repeatedly performed. Further, the scheduling control program causes the electronic device to perform the process of judging whether an input operation input via an input unit of the device while a standby image is being displayed on an image display unit of the device matches a condition that is stored in advance in a condition storage unit and is related to the execution of the ringing process of the scheduled event or judging whether the form of the device matches the condition stored in the condition storage unit at the scheduled time when the ringing process is to be performed. Further, if it is determined that the input operation matches the condition or that the form of the device matches the condition, the scheduling control program causes the electronic device to perform the process of setting the ringing process of only the nearest scheduled event to be non-execution from among the repeatedly-scheduled events. The scheduling control program may be distributed to a computer via a communication network such as the Internet. Further, the scheduling control program may be recorded on a memory or a hard disk with which the electronic device is provided or any other computer-readable recording medium and may be executed when being read from the recording medium by a computer.

When the electronic device according to an aspect is used, it is possible to cancel only the nearest one of the repeatedly-scheduled events by performing the simple operation.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An electronic device comprising:
a memory; and
a processor coupled to the memory, wherein the processor executes a process comprising:
storing a condition related to periodically-scheduled events that involve ringing of the electronic device in the memory;
judging whether an input operation input via an input unit of the electronic device matches the condition stored in the memory; and
when the judging determines that the input operation matches the condition, inhibiting the ringing scheduled at a nearest ringing time from being performed, calculating a ringing time that arrives following the nearest ringing time according to a periodical schedule, and configuring a setting so as to enable the ringing scheduled at the calculated ringing time.

2. The electronic device according to claim 1, wherein the memory stores therein, as the condition, an operation to long-press one of keys of the electronic device while a standby image is being displayed or an operation to select a skip setting menu from a sub-menu that is displayed when a scheduling icon displayed on the standby image is selected.

3. A non-transitory computer-readable storage medium containing instructions for controlling scheduling that, when executed by an electronic device, cause the electronic device to perform:
judging whether an input operation input via an input unit of the electronic device while a standby image is being displayed on an image display unit of the electronic device matches a condition stored in a condition storage unit storing therein the condition related to periodically-scheduled events that involve ringing of the electronic device; and
when the input operation is determined to match the condition, inhibiting the ringing scheduled at a nearest ringing time from being performed, calculating a ringing time that arrives following the nearest ringing time according to a periodical schedule, and configuring a setting so as to enable the ringing scheduled at the calculated ringing time.
